(19) United States
(12) Patent Application Publication
(10) Pub. No.: US 2025/0115700 A1
(43) Pub. Date: Apr. 10, 2025

(54) (METH)ACRYLATED HYPERBRANCHED POLYMERS, METHOD OF MAKING, COMPOSITIONS INCLUDING THE SAME, AND ELECTRONIC DEVICE

(71) Applicant: 3M INNOVATIVE PROPERTIES COMPANY, ST. Paul, MN (US)

(72) Inventor: Claire K. Hartmann-Thompson, Lake Elmo, MN (US)

(21) Appl. No.: 18/729,434

(22) PCT Filed: Feb. 8, 2023
(86) PCT No.: PCT/IB2023/051132

§ 371 Date: Jul. 16, 2024

Related U.S. Application Data
(60) Provisional application No. 63/312,538, filed on Feb. 22, 2022.

(51) Int. Cl. C08F 230/08; C08F 2/50; C08F 222/10

(52) U.S. Cl. CPC C08F 230/085; C08F 2/50; C08F 222/102

(57) ABSTRACT

A (meth)acrylated hyperbranched polymer consists of C, H, Si, optionally O, and optionally F atoms. The (meth)acrylated hyperbranched polymer comprises end groups, and at least some of the end groups comprise (meth)acryloyloxy groups. A method of making and a curable composition including the (meth)acrylated hyperbranched polymer are also disclosed. An electronic device includes an at least partially cured form of curable composition.

### BACKGROUND

Organic Light Emitting Diodes (OLEDs) are often fabricated using inkjet printing techniques, especially thin film encapsulation (TFE) layers that prevent air and moisture ingress into the OLED. This generally requires curable compositions that are low viscosity liquids and typically solvent-free. Control of numerous additional properties is also typically desirable depending on the particular device requirements. Examples can include, for example, refractive index, dielectric constant, high glass transition (T_{g}) of the cured composition for improved long-term aging performance, and etch resistance to plasma deposition used in TFE fabrication.

Hyperbranched polymers are highly branched polymeric compounds, having successive branching repeating units, and having a multiplicity of chain-ends. In some cases (e.g., AB_{X} polymerization) they have a central focal unit or core, while in other cases (e.g., A₂+B₃ polymerization) they do not. In the preceding sentence, the subscripts indicate the number of reactive groups on the monomer (e.g., A₂ refers to a first monomer having two reactive A groups while B₃ refers to a second monomer having three reactive B groups). The A groups react with B groups, but not with other A groups. Likewise, the B groups react with A groups, but not with other B groups. In general, they have irregularly branched and polydisperse structures, which distinguishes them from dendrimers which have well-controlled size, shape and a monodisperse structure. The most common synthetic route for making hyperbranched polymers involves a one-pot procedure in which a single monomer having one A group and x B groups (where x>2) that are reactive with the A group are polymerized to form an AB_{X} hyperbranched polymer. Likewise, it is possible to polymerize a first monomer having w A groups (wherein w is a positive integer) with a second monomer having x B groups (wherein x is a positive integer) resulting in an A_{W}Bₓ hyperbranched polymer (e.g., A₂B₃ or A₂B₄) hyperbranched polymer) by reacting the monomers under conditions that minimize crosslinking and intramolecular reactions. A simplified exemplary schematic A₂B₄ hyperbranched polymer synthesis is shown in Scheme I, below:

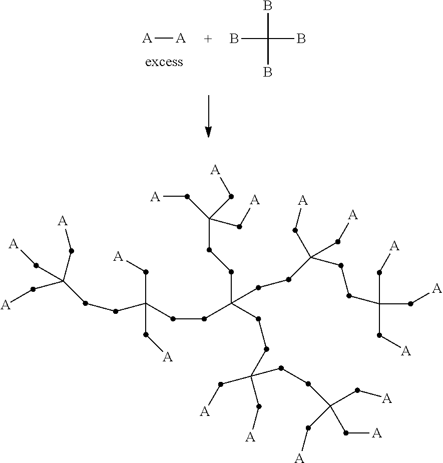

In Scheme I, above, the “⋅” symbol indicates a residue resulting from coupling A and B reactive groups.

Further details concerning hyperbranched polymers can be found in Voit et al., “Hyperbranched and Highly Branched Polymer Architectures-Synthetic Strategies and Major Characterization Aspects”, Chemical Reviews 2009, 109, 5924-5973.

### SUMMARY

There is a need for new materials (e.g., inkjettable materials) that can be used in the manufacture of OLED thin film encapsulation layers, and especially materials that are easily adjusted to achieve a balance of the aforementioned properties.

Accordingly, in one aspect, the present disclosure provides a (meth)acrylated hyperbranched polymer consisting of C, H, Si, optionally O, and optionally F atoms, wherein the (meth)acrylated hyperbranched polymer comprises end groups, and wherein at least some of the end groups comprise (meth)acryloyloxy groups.

In some embodiments, the (meth)acrylated hyperbranched polymer comprises a first reaction product of first components comprising:
i) a primary alkenyl (meth)acrylate;
ii) a hyperbranched polymer comprising a second reaction product of second components comprising:
   a) at least one first monomer component independently having p Si—H groups and consisting of C, H, Si, optionally O, and optionally F atoms, wherein each p is independently an integer greater than or equal to 2;
   b) at least one second monomer component independently having q vinyl groups and consisting of C, H, optionally Si, optionally O, and optionally F atoms, wherein each q is independently an integer greater than or equal to 2, wherein p/q is at least 2.1; and
   c) at least one hydrosilylation reaction catalyst.

In another aspect, the present disclosure provides a method of making a hyperbranched polymer, the method comprising:
i) forming a hyperbranched polymer by combining first components comprising:
   a) at least one first monomer component independently having p Si—H groups and consisting of C, H, Si, optionally O, and optionally F atoms, wherein each p is independently an integer greater than or equal to 2;
   b) at least one second monomer component independently having q vinyl groups and consisting of C, H, optionally Si, optionally O atoms, and optionally F atoms, wherein each q is independently an integer greater than or equal to 2, wherein p/q is at least 2.1 to form a hyperbranched polymer; and
   c) at least one hydrosilylation reaction catalyst; and
ii) endcapping the hyperbranched polymer with at least one primary alkenyl (meth)acrylate.

In yet another aspect, the present disclosure provides a curable composition comprising:
a (meth)acrylated hyperbranched polymer according to the present disclosure;
at least one free-radically polymerizable monomer having at least one (meth)acryloyloxy groups; and
an effective amount of a free-radical initiator for curing the curable composition, wherein at least one component in the curable composition carries at least two (meth)acryloyloxy groups.

In another aspect, the present disclosure provides an at least partially cured curable composition according to the present disclosure.

In yet another aspect, the present disclosure provides an electronic device comprising an at least partially cured curable composition according to the present disclosure disposed on an optical electronic component.

As used herein:
“—C₆H₄—” refers to a para-phenylene group unless otherwise indicated;
“endcapping” refers to covalently attaching a chemical group to an end of a polymer backbone.
“(meth)acryloyloxy” refers to methacryloyloxy and/or acryloyloxy; and
“(meth)acryloxy” and “(meth)acryloyloxy” are equivalent terms.

Features and advantages of the present disclosure will be further understood upon consideration of the detailed description as well as the appended claims.

### BRIEF DESCRIPTION OF THE DRAWINGS

FIG. 1 is a schematic side view of an electronic device 100 according to one embodiment of the present disclosure.

It should be understood that numerous other modifications and embodiments can be devised by those skilled in the art, which fall within the scope and spirit of the principles of the disclosure. The figures may not be drawn to scale.

### DETAILED DESCRIPTION

In some embodiments, (meth)acrylated hyperbranched polymers according to the present disclosure may consist of C, H, and Si atoms (i.e., C, H, and Si). In some embodiments, they consist of C, H, Si and O atoms. In some embodiments, they consist of C, H, Si and F atoms. In some embodiments, they consist of C, H, Si, O, and F atoms.

The (meth)acrylated hyperbranched polymer is formed by A_{W}Bₓ polymerization; for example, as discussed hereinabove. Examples may include A₂B₃, A₂B₄, A₃B₂, and A₄B₂, wherein A monomers contain Si—H (hydrosilyl) functional groups and B monomers contain primary alkenyl (i.e., vinyl) functional groups.

Useful first monomers (A monomers) may have p Si—H groups and consist of C, H, Si, optionally O, and optionally F atoms. In some embodiments, useful second organosilanes have from 4 to 50 carbon atoms (e.g., 4 to 50, 4 to 36, 4 to 18, or 4 to 12 carbon atoms), 2 to 10 silicon atoms (e.g., 2 to 10, 2 to 6, or 2 to 4 silicon atoms), and 0 to 9 oxygen atoms (e.g., 0 to 9, 0 to 6, 0 to 4, 0 to 2, or 0 to 1 oxygen atom). If O is present, Z is preferably a single oxygen atom or the oxygen is present in an ether linkage. Each p is independently an integer greater than or equal to 2 (e.g., 3, 4, 5, 6, 7, or 8). In some embodiments, useful second organosilanes consist of C, H, and Si atoms. In some embodiments, useful second organosilanes include aromatic carbon atoms, while in other embodiments they do not.

In some embodiments, the first monomer is represented by the formula

Z(SiR¹₂H)ₐ

Each Z is independently an a-valent radical composed of Si and O, or Z is an a-valent radical composed of C, H, and optionally O, and optionally F

Each Z independently has from 1 to 12 carbon atoms (in some embodiments, 1 to 8 carbon atoms, or 1 to 6 carbon atoms). For example, Z may be a carbon atom (tetravalent), an oxygen atom (divalent), methylene (divalent), ethan-1,2-diyl (divalent), propan-1,3-diyl (divalent), CH₃CH₃(CH₂—)₃ (trivalent). In many embodiments, Z may contain at least one aromatic group or it can be free of aromatic groups (e.g., phenyl rings). In some embodiments Z is phenylene.

Each R is independently a hydrocarbyl group having from 1 to 12 carbon atoms (e.g., methyl, ethyl, n-propyl, isopropyl, n-butyl, sec-butyl, n-pentyl, n-hexyl, phenyl, biphenylyl, and alkyl-substituted phenyl). In some embodiments, R¹ comprises an optionally substituted phenyl group (e.g., phenyl, biphenylyl, tolyl, xylyl, methoxyphenyl). Subscript a is an integer from 2 to 8 (i.e., 2, 3, 4, 5, 6, 7, or 8). Exemplary monomers A include: 1,1,4,4-tetramethyl-1,4-disilabutane; 1,4-bis(dimethylsilyl)benzene; 1,2-bis(dimethylsilyl) benzene; tris(dimethylsiloxy) phenylsilane; 1,1,3,3- tetramethyldisiloxane; 1,3-disila-propane; bis[(p-dimethylsilyl)phenyl]ether; 1,3,5,7,9-pentamethylcyclopentasiloxane; 1,1,3,3,5,5-hexamethyltrisiloxane; 1,3,5,7-tetramethylcyclotetrasiloxane; 1,3-diphenyltetrakis(dimethylsiloxy)-disiloxane; tris(dimethylsiloxy)ethoxysilane; methyltris(dimethylsiloxy)silane; 1,1,1,3,3,5,5-heptamethyl-trisiloxane; 1,1,3,3-tetraisopropyldisiloxane; 4,4′-bis(dimethylsilyl)biphenyl; trifluoropropyltris-(dimethylsiloxy)silane; and tetrakis(dimethylsiloxy) silane. Combinations of monomers may also be used. The foregoing Si—H group-containing compounds are available from commercial suppliers such as, for example, Gelest, Inc. and/or can be synthesized by known methods. Of these, 1,1,4,4-tetramethyl-1,4-disilabutane, 1,4-bis(dimethylsilyl)benzene, bis[(p-dimethylsilyl)phenyl]ether, trifluoropropyltris-(dimethylsiloxy) silane are preferred in some embodiments.

Organohydrosilanes may be synthesized by hydride reduction of corresponding chloro-or alkoxysilanes using reactive metal hydrides such as lithium aluminum hydride (LiAlH4), sodium borohydride, and diisobutylaluminum hydride (DIBAL-H), or they may be obtained from commercial sources, for example. Still other useful aliphatic carbosilanes having m Si—H groups may include dialkyldihydridosilanes such as, for example, dimethylsilane, dipropylsilane, and dibutylsilane.

The second monomer (monomer B) may independently have q vinyl groups and consist of C, H, optionally Si, optionally O, and optionally F atoms. In some embodiments, useful second monomers have from 4 to 50 carbon atoms (e.g., 4 to 50, 4 to 36, 4 to 18, or 4 to 12 carbon atoms), 2 to 10 silicon atoms (e.g., 2 to 10, 2 to 6, or 2 to 4 silicon atoms), and 0 to 9 oxygen atoms (e.g., 0 to 9, 0 to 6, 0 to 4, 0 to 2, or 0 to 1 oxygen atom). If O is present, it is preferably in an ether linkage (i.e., C—O—C). Each q is independently an integer greater than or equal to 2 (e.g., 3, 4, 5, 6, 7, or 8). In some embodiments, useful second monomers consist of C, H, Si, and optionally O. In some embodiments, useful second monomers consist of C, H, and optionally O atoms. In some embodiments, useful second monomers comprise an aromatic group, while in other embodiments they do not.

In some embodiments, useful second monomers are independently represented by the formula

Si(OSiR²₂CH═CH₂)_{b}(R²CH═CH₂)_{c}(R¹)_{d}

Each R² is independently a direct bond (i.e., a covalent bond) or a hydrocarbylene group having 1 to 12 carbon atoms. Examples include methylene, ethylene, propane-1,3-diyl, propane-1,2-diyl, butane-1,4-diyl, butane-1,3-diyl, pentane-1,5-diyl, pentane-1,4-diyl, hexane-1,6-diyl, octan-1,8-diyl, decan-1,10-diyl, dodecan-1,12-diyl, 1,4-phenylene, and 1,8-biphenylene.

Each R¹ is as previously defined.

Subscript b is an integer from 0 to 4 (i.e., 0, 1, 2, 3, or 4), c is an integer from 0 to 4 (i.e., 0, 1, 2, 3, or 4), and d is an integer from 0 to 2 (i.e., 0, 1, or 2), with the proviso that b+c≥2 (in some embodiments, b+c≥3) and b+c+d=4.

Exemplary second monomers include: 1,3-divinyl-1,3-diphenyl-1,3-dimethyldisiloxane; 1,1,3,3-tetraphenyl-1,3-divinyldisiloxane; 1,4-bis (vinyldimethylsilyl) benzene; 1,5-divinyl-3-phenylpentamethyl-trisiloxane; 1,3-divinyl-1,1,3,3,-tetramethyldisiloxane; 1,4-divinyl-1,1,4,4-tetramethyl-1,4-disilabutane; divinyldimethylsilane; 1,5-divinyl-3,3-diphenyl-1,1,5,5-tetramethyltrisiloxane; 1,3-divinyltetrakis(trimethylsiloxy)disiloxane; 1,5-divinylhexamethyltrisiloxane; bis (divinyl)-terminated polydimethylsiloxane; 1,3-divinyltetraethoxydisiloxane; 1,3-divinyl-1,3-dimethyl-1,3-dimethoxydisiloxane; trivinylmethoxysilane; 1,3,5-trivinyl-1,3,5-trimethylcyclotrisiloxane; 1,3,5-trivinyl-1,1,3,5,5-pentamethyltrisiloxane; 1,3,5,7-tetravinyl-1,3,5,7-tetramethylcyclotetrasiloxane; 1,1,3,3-tetravinyldimethyldisiloxane; tetravinylsilane; tetraallylsilane; 1,3,5,7,9-pentavinyl-1,3,5,7,9-pentamethylcyclopentasiloxane; hexavinyldisiloxane; 1,3,5,7,9,11-hexavinylhexamethyl-cyclohexasiloxane; and aliphatic polyenes comprising at least two (e.g., 2, 3, 4, 5,or 6) vinyl groups such as 1,7-octadiene, 1,5-hexadiene, diallyl ether, 1,3,5-trivinylcyclohexane, divinylbenzene, and 4,4′-divinylbiphenyl.

The foregoing vinyl compounds are available from commercial suppliers such as, for example, Sigma-Aldrich, Saint Louis Missouri, and Gelest, Inc., Morrisville, Pennsylvania, and/or can be synthesized by known methods.

Useful second organosilanes may independently have p Si—H groups and consist of C, H, Si, and optionally O atoms. In some embodiments, useful second organosilanes have from 4 to 50 carbon atoms (e.g., 4 to 50, 4 to 36, 4 to 18, or 4 to 12 carbon atoms), 2 to 10 silicon atoms (e.g., 2 to 10, 2 to 6, or 2 to 4 silicon atoms), and 0 to 9 oxygen atoms (e.g., 0 to 9, 0 to 6, 0 to 4, 0 to 2, or 0 to 1 oxygen atom). If O is present, Z is preferably a single oxygen atom or the oxygen is present in an ether linkage. Each p is independently an integer greater than or equal to 2 (e.g., 3, 4, 5, 6, 7, or 8). In some embodiments, useful second organosilanes consist of C, H, and Si atoms. In some embodiments, useful second organosilanes include aromatic carbon atoms, while in other embodiments they do not.

The (meth)acrylated hyperbranched polymer is terminated by end groups. At least some of the end groups comprise (meth)acryloxy groups. End groups may be incorporated during or after formation of the hyperbranched polymer. For example, an end group may be attached by reaction with a reactive group of a terminal monomer unit of a growing or fully polymerized hyperbranched polymer. Attachment of the end group may terminate further growth of a particular hyperbranched polymer chain. (Meth)acrylated hyperbranched polymers can be made by endcapping hyperbranched polymer polymerizable reactive groups with endcapping compounds that are reactive with those polymerizable reactive groups and contain one or more (typically one) (meth)acryloyloxy group.

Exemplary end groups will necessarily depend on the functionality of the monomers used to form the hyperbranched polymer. For example, if hyperbranched polymer is formed by hydrosilylation, then the polymer chains may have Si—H at the propagating end of the polymer chain branch. Reaction with a primary alkene (free of any further Si—H groups) thus may effectively terminate chain propagation along that branch. Likewise, if the polymer chain branch has a vinyl group at its propagating end, then reaction with a hydrosilyl group (H—Si), free of any further vinyl groups, may effectively terminate chain propagation along that branch. The amount of endcapping agent (e.g., primary alkenyl (meth)acrylate and/or primary alkene) should generally be at least sufficient to endcap substantially all active polymerization sites on the hyperbranched polymer backbone.

Primary alkenyl (meth)acrylates are useful as endcapping agents during polymerizations. This results in a hyperbranched polymer having (meth)acrylate functionality. If desired, a primary monoalkene can also be used as an endcapping agent, in addition, as long as at least some of the end groups comprise (meth)acryloyloxy groups. For example, at least 20, at least 30, at least 40, at least 50, at least 60, at least 70, at least 80, at least 90 percent, or even all of the end groups may comprise a (meth)acryl group.

In preferred embodiments, the end groups have from 4 to 16 carbon atoms, preferably 7 to 17 carbon atoms, although other groups are permissible. Preferably, the end groups consist of C, H, and optionally O atoms.

Exemplary endcapping agents include primary alkenyl (meth)acrylates (e.g., allyl (meth)acrylate, 3-butenyl (meth)acrylate, 5-hexenyl (meth)acrylate, and 7-octenyl (meth)acrylate) and primary monoalkenes (i.e., having a vinyl group) such as 1-pentene, 1-hexen, 1-heptene, 1-octene, or 1-decene. Allyl (meth)acrylate is a preferred endcapping agent.

To form a hyperbranched polymer backbone, the first and second monomers are combined with a hydrosilylation catalyst. In some embodiments, a primary alkenyl (meth)acrylate, and optionally a primary alkene, endcapping agent is added at this point as well, although in other embodiments it is added after polymerization has proceeded for a while.

Hydrosilylation, also called catalytic hydrosilylation, describes the addition of Si—H bonds across unsaturated bonds. When hydrosilylation is used to synthesize hyperbranched polymers according to the present disclosure, vinyl group(s) on the first organosilane react with Si—H group(s) on the second organosilane. The stoichiometry of the reactants is adjusted such that there is at least a 2.1 equivalent excess of vinyl groups relative to Si—H groups; that is, p/q is at least 2.1. This ensures that the hyperbranched polymer will have pendant vinyl groups, and helps limit unwanted crosslinking of the polymer during its synthesis. In some embodiments the ratio p/q is at least 3.5, 4, 4.5, or even at least 5.

The hydrosilylation reaction may be catalyzed by a suitable catalyst (e.g., a platinum catalyst or a rhodium catalyst), and in some cases heat is applied to effect the curing reaction. In this reaction, the Si—H adds across the double bond to form new C—H and Si—C bonds. This process in described, for example, in PCT Publication No. WO 2000/068336 (Ko et al.), and PCT Publication Nos. WO 2004/111151 and WO 2006/003853 (Nakamura).

Useful hydrosilylation catalysts may include thermal catalysts and/or photocatalysts. Exemplary thermal catalysts include platinum complexes such as H₂PtCl₆ (Speier's catalyst); organometallic platinum complexes such as, for example, a coordination complex of platinum and a divinyldisloxane (Karstedt's catalyst); and chloridotris(triphenylphosphine)rhodium(I) (Wilkinson's catalyst),

Useful platinum photocatalysts are disclosed, for example, in U.S. Pat. No. 7,192,795 (Boardman et al.) and references cited therein. Certain preferred platinum photocatalysts are selected from the group consisting of Pt (II) β-diketonate complexes (such as those disclosed in U.S. Pat. No. 5,145,886 (Oxman et al.)), (η5-cyclopentadienyl)tri(σ-aliphatic)platinum complexes (such as those disclosed in U.S. Pat. No. 4,916,169 (Boardman et al.) and U.S. Pat. No. 4,510,094 (Drahnak)), and C₇₋₂₀-aromatic substituted (η5-cyclopentadienyl)tri(σ-aliphatic)platinum complexes (such as those disclosed in U.S. Pat. No. 6,150,546 (Butts)). Hydrosilylation photocatalysts are activated by exposure to actinic radiation, typically ultraviolet light, for example, according to known methods. The amount of hydrosilylation catalyst used may be any effective amount for causing hydrosilylation. In some embodiments, the amount of hydrosilylation catalyst is in an amount of from about 0.5 to about 30 parts of platinum per million parts of the total weight of Si—H and vinyl group-containing compounds combined, although greater and lesser amounts may also be used. In some cases, mere mixing is sufficient. In other cases, heating and/or irradiation with ultraviolet light may be helpful. Polymerization conditions are selected to reduce cross-linking reactions and intramolecular cyclization reactions. Important to this, is control of concentration and the stoichiometric ratio of the first and second monomers. For example, the stoichiometry (based on equivalents of polymerizable groups) of Si—H groups to primary alkenyl (vinyl) groups should generally be at least p/q is at least 2.1. Examples include at least 2.1, at least 2.2, and least 2.3, at least 2.4, at least 2.5, at least 2/6, at least 2.7, at least 2.8, at least 2.9, at least 3.0, or even at least 3.1. Typically, high solution concentrations of monomers favor polymer chain growth over internal cyclization reactions. Selection of suitable reaction conditions is within the capabilities of those having ordinary skill in the art.

(Meth)acrylated hyperbranched polymers can be combined with additional free-radically polymerizable monomers and an effective amount of a free-radical polymerization initiator to provide a curable composition such as, for example, and inkjet printable curable composition.

Useful free-radically polymerizable monomers having at least two (meth)acryloyloxy groups may comprise two, three, four, five, six, or more (meth)acryloyloxy groups. Exemplary such monomers include ethylene glycol di(meth)acrylate, hexanediol di(meth)acrylate, triethylene glycol di(meth)acrylate, trimethylolpropane tri(meth)acrylate, glycerol tri(meth)acrylate, pentaerythritol tri(meth)acrylate, ethoxylated trimethylolpropane tri(meth)acrylate, neopentyl glycol di(meth)acrylate, pentaerythritol tetra(meth)acrylate, propoxylated trimethylolpropane triacrylate, dipentaerythritol penta(meth)acrylate, sorbitol tri(meth)acrylate, sorbitol hexa(meth)acrylate, Bisphenol A di(meth)acrylate, 1,10-decanediol diacrylate, ethoxylated Bisphenol A di(meth)acrylates, tricyclodecanedimethanol diacrylate, and mixtures thereof. Additional useful polyfunctional (meth)acrylate oligomers include polyether oligomers such as a polyethylene glycol 200 diacrylate marketed by Sartomer Company as SR 259; and polyethylene glycol 400 diacrylate marketed by Sartomer Company as SR 344.

If desired, one or more reactive diluent(s) and/or solvent(s) can be added to the curable composition; however, it is preferably solvent-free (i.e., less than 0.1 percent by weight of inert organic solvent). Reactive diluents having only one (meth)acryloyloxy group can become covalently incorporated into the cured composition, and may be useful for reducing viscosity. Examples include the (meth)acrylic esters of monohydric alcohols, particularly alkanols having from 1 to 18 carbon atoms, such as methyl (meth)acrylate, ethyl (meth)acrylate, butyl (meth)acrylate, n-hexyl (meth)acrylate, cyclohexyl (meth)acrylate, isooctyl (meth)acrylate, isobornyl (meth)acrylate, isodecyl (meth)acrylate, ethylhexyl (meth)acrylate, and isostearyl (meth)acrylate.

(Meth)acrylic monomers are widely available from commercial suppliers such as, for example, Sartomer Co., Exton, Pennsylvania.

Polymerizable acrylic monomers and oligomers such as those above, are typically cured with the aid of at least one free-radical thermal initiator (e.g., organic peroxides) and/or photoinitiator (e.g., thioxanthones, acylphosphines, acylphosphine oxides, benzoin ketals, alpha-hydroxy ketones, and alpha-dialkylamino ketones). Preferably, a photoinitiator is used.

Exemplary photoinitiators (i.e., photoactivated free-radical initiators) include α-cleavage photoinitiators (Type I) such as benzoin and its derivatives such as a-methylbenzoin; α-phenylbenzoin; α-allylbenzoin; α-benzylbenzoin; benzoin ethers such as benzil dimethyl ketal (available as IRGACURE 651 from Ciba Specialty Chemicals, Tarrytown, New York), benzoin methyl ether, benzoin ethyl ether, benzoin n-butyl ether; acetophenone and its derivatives such as 2-hydroxy-2-methyl-1-phenyl-1-propanone, and 1-hydroxycyclohexyl phenyl ketone; and acylphosphines, acylphosphine oxides, and acylphosphinates such as diphenyl-2,4,6-trimethylbenzoylphosphine oxide, and ethyl (2,4,6-trimethylbenzoyl)phenyl phosphinate. One useful photoinitiator, a difunctional α-hydroxyketone, is available as ESACURE ONE from IGM Resins, Waalwijk, The Netherlands. Other exemplary photoinitiators include Type II photoinitiators such as anthraquinones (e.g., anthraquinone, 2-ethylanthraquinone, 1-chloroanthraquinone, 1,4-dimethylanthraquinone, 1-methoxyanthraquinone) and benzophenone and its derivatives (e.g., phenoxybenzophenone, phenylbenzophenone).

In many embodiments, the curable composition has an inkjet printable viscosity (i.e., dynamic viscosity) of less than 200 mPa sec at 60° C., preferably less than 100 mPa sec at 60° C., and more preferably 25 to 50 mPa sec at 25° C.

In many embodiments, the curable composition has a refractive index of from 1.40 to 1.60. Likewise, the at least partially cured curable composition may have a refractive index of from 1.35 to 1.60, if desired.

Further, curable compositions according to the present disclosure and/or the corresponding at least partially cured curable compositions may have a dielectric constant of less than or equal to 3.0 at a measurement frequency of 1 megahertz.

Additionally, the at least partially cured curable compositions may have a glass transition temperature T_{g} of at least >100° C. and/or exhibit a degree of plasma etch resistance.

Curable compositions according to the present disclosure may be dispensed/coated onto a substrate by any suitable method including, for example, screen printing, inkjet printing, flexographic printing, and stencil printing. Of these, inkjet printing (e.g., thermal inkjet printing or piezo inkjet printing) is particularly well-suited for use with the curable compositions according to the present disclosure. To be useful in inkjet printing techniques, preferably the curable composition is formulated to be solvent-free, although organic solvent may be included. Inkjet printing may be carried out over a range of temperatures (e.g., 20° C. to 60° C.). Inkjet printable curable compositions should typically have a shear viscosity of less than about 100 centipoise (100 mPa·s), preferably less than 50 centipoise (50 mPa·s), more preferably less than 30 centipoise (30 mPa·s), and most preferably less than 20 centipoise (20 mPa·s) at the printing temperature.

Curing may be accomplished/accelerated by heating (e.g., in an oven or by exposure to infrared radiation) and/or preferably by exposure to actinic radiation (e.g., ultraviolet and/or electromagnetic visible radiation), for example. Selection of sources of actinic radiation (e.g., xenon flash lamp, medium pressure mercury arc lamp) and exposure conditions is within the capability of those having ordinary skill in the art.

In some embodiments, curable compositions according to the present disclosure are formulated as inks (e.g., screen printing inks or inkjet printable inks) or other dispensable fluids that can be applied to substrates such as electronic displays and optical electronic components thereof, for example. Examples include Organic Light Emitting Diodes (OLEDs), Quantum Dot Light Emitting Diodes (QDLEDs), Micro Light Emitting Diodes (μLEDs), and Quantum Nanorod Electronic Devices (QNEDs). Advantageously, inkjet printable curable compositions according to the present disclosure are suitable for use with optical electronic components due to their balance of dielectric constant and refractive index.

Curable compositions according to the present disclosure can be disposed on a substrate and at least partially cured (e.g., cured to a C-stage) to provide an electronic device including an optical electronic component such as, for example, at least one of an Organic Light Emitting Diode (e.g., as included in an OLED display), a Quantum Dot Light Emitting Diode, a Micro Light Emitting Diode, or a Quantum Nanorod Electronic Device.

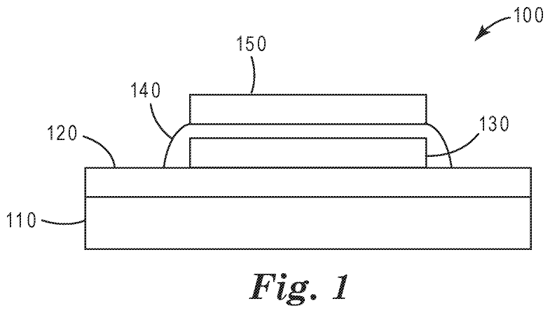

Referring now to FIG. 1, exemplary electronic device 100 comprises an OLED display 130 supported on Thin Film Transistor (TFT) 120 array on an OLED mother glass substrate 110. Thin Film Encapsulation (TFE) layer 140 comprises a cured composition according to the present disclosure composition 140 according to the present disclosure is disposed on and encapsulated OLED display 130. Touch sensor assembly (e.g., an On-Cell Touch Assembly (OCTA)) 150 is disposed on cured composition 140.

Objects and advantages of this disclosure are further illustrated by the following non-limiting examples, but the particular materials and amounts thereof recited in these examples, as well as other conditions and details, should not be construed to unduly limit this disclosure.

EXAMPLES

Unless otherwise noted, all parts, percentages, ratios, etc. in the Examples and the rest of the specification are by weight. In the examples “phr” refers to parts per hundred parts of resin, “¹H NMR” refers to proton nuclear magnetic resonance, “DSC” refers to differential scanning calorimetry, “GPC” refers to gel permeation chromatography, Mₙ refers to number average molecular weight, M_{w} refers to weight average molecular weight, and ELSD refers to an evaporative light scattering detector. Table 1, below, lists materials used in the examples and their sources.

TABLE 1

| MATERIAL | ABBREVIATION | SOURCE |
|---|---|---|
| 1,1,4,4-tetramethyl-1,4-disilabutane | — | obtained from Gelest, Inc., Morrisville, |
| | | Pennsylvania |
| 1,10-decanediol diacrylate | DDA | obtained from Miwon, Exton, |
| | | Pennsylvania |
| 1,5-hexadiene | — | obtained from Alfa Aesar, Ward Hill, |
| | | Massachusetts |
| 1-pentene | — | obtained from TCI America, Portland, |
| | | Oregon |
| 4,4′-bis(dimethylsilyl)biphenyl | — | obtained from Gelest, Inc. |
| acrylate ester that derives from an | CN309 | obtained as CN309 from Sartomer, Exton, |
| aliphatic hydrophobic backbone | | Pennsylvania |
| allyl methacrylate | — | obtained from TCI America |
| bis[(p-dimethylsilyl)phenyl]ether | — | obtained from Gelest, Inc. |
| diphenyl(2,4,6-trimethylbenzoyl)- | TPO | obtained as OMNIRAD-TPO from GM |
| phosphine oxide | | Resins USA, Charlotte, North Carolina |
| fluorosilicone coated polyester film | L1 | obtained as SILFLU M117 from |
| | | SILICONATURE USA, LLC, Chicago, |
| | | Illinois |
| fluorosilicone coated polyester film | L2 | obtained as product number 5199 from |
| | | Loparex, Cary, North Carolina |
| hydroxy pivalic acid neopentyl glycol | HPNDA | obtained from Miwon |
| diacrylate | | |
| isobornyl acrylate | IBOA | obtained from Miwon |
| isostearyl acrylate | ISTA | obtained as NK-ESTER S1800ALC from |
| | | Shin-Nakamura, Tokyo, Japan |
| platinum divinyltetramethyldisiloxane | PtCat | obtained from Gelest, Inc. |
| complex, 3 wt. % in vinyl-terminated | | |
| PDMS | | |
| propoxylated trimethylolpropane | M360 | obtained as M360 from Miwon |
| triacrylate | | |
| tetraallylsilane | — | obtained from Gelest, Inc. |
| tetravinylsilane | — | obtained from Millipore-Sigma, St. Louis, |
| | | Missouri |
| tricyclodecanedimethanol diacrylate | TAc | obtained as T-ACRYLAT from 3M |
| | | ESPE, Seefeldt, Germany |
| 3,3,3- | — | obtained from Gelest, Inc. |
| trifluoropropyltris(dimethylsiloxy)silane | | |

### EXAMPLE 1

### Synthesis of HBP 1

One drop of PtCat was added to a solution of 1,1,4,4-tetramethyl-1,4-disilabutane (23.59 grams, 0.161 mol, 3.1 fold excess of SiH group) and tetraallylsilane (5.00 grams, 0.026 mol) in toluene (100 mL). After an initial exotherm, the reaction mixture was stirred at room temperature for 4 days, and toluene and excess monomer were removed in vacuo to give the product as a pale yellow oil. ¹H NMR (CDCl₃) 4.14 mmol/g SiH. GPC (toluene/ELSD): Mₙ=1500 g/mol, M_{w}=1600 g/mol, polydispersity=1.07.

PtCat was then added to a solution of the SiH-terminated polymer prepared above (7.08 grams, 0.0293 mol SiH) and allyl methacrylate (3.70 grams, 0.0293 mol) in toluene (50 mL). After an initial exotherm, the reaction mixture was stirred at room temperature for 3 days, and toluene was removed in vacuo to give HBP 1 as an oil. H NMR (CDCl₃) 1.74 mmol/g methacrylate. GPC (toluene/ELSD): Mₙ=1000 g/mol, M_{w}=1900 g/mol, polydispersity=1.85. DSC (10° C. min⁻¹, N₂):−75° C. (T_{g}). Refractive index=1.476.

### EXAMPLE 2

### Synthesis of HBP 2

One drop of PtCat was added to a solution of the SiH-terminated polymer precursor to HBP 1 (1.55 grams, 6.42 mmol SiH), allyl methacrylate (0.40 grams, 3.21 mmol), and 1-pentene (0.23g, 3.21 mmol in toluene (30 mL). The reaction mixture was stirred at room temperature for 2 days, and toluene was removed in vacuo to give HBP 2 as a colorless oil. H NMR (CDC13) 0.61 mmol/g methacrylate. GPC (toluene/ELSD): Mₙ=1900 g/mol, M_{w}=2100 g/mol, polydispersity=1.13. DSC (10° C. min⁻¹, N₂):−86° C. (T_{g}). Refractive index=1.473.

### EXAMPLE 3

### Synthesis of HBP 3

One drop of PtCat was added to a solution of 1,1,4,4-tetramethyl-1,4-disilabutane (23.59 grams, 0.161 mol, 3.1 fold excess of SiH group) and tetravinylsilane (3.54 grams, 0.026 mol) in toluene (100 mL). After an initial exotherm, the reaction mixture was stirred at room temperature for 2 days, and toluene and excess monomer were removed in vacuo to give a pale yellow oil. H NMR (CDCl₃) 4.79 mmol/g SiH. GPC (toluene/ELSD): Mₙ=1700 g/mol, M_{w}=2000 g/mol, polydispersity=1.20.

One drop of PtCat was then added to a solution of the pale yellow oil prepared above (8.00 grams, 0.0383 mol SiH) and allyl methacrylate (4.83 grams, 0.0383 mol) in toluene (50 mL). After an initial exotherm, the reaction mixture was stirred at room temperature for 2 days, and toluene was removed in vacuo to give HBP 3 as an oil. ¹H NMR (CDCl₃) 2.32 mmol/g methacrylate. GPC (toluene/ELSD): Mₙ=840 g/mol, M_{w}=2300 g/mol, polydispersity=2.75. DSC (10° C. min⁻¹, N₂): −64° C. (T_{g}). Refractive index=1.483.

### EXAMPLE 4

### Synthesis of HBP 4

One drop of PtCat was added to a solution of the SiH-terminated polymer precursor to HBP 3 above (6.10 grams, 0.0292 mol SiH), allyl methacrylate (3.62 grams, 0.0287 mol) and 1-pentene (0.67 g, 9.58 mmol in toluene (50 mL). The reaction mixture was stirred at room temperature for 2 days, and toluene was removed in vacuo to give the product as a colorless oil. ¹H NMR (CDCl₃) 1.82 mmol/g methacrylate. GPC (toluene/ELSD): Mₙ=1200 g/mol, M_{w}=2200 g/mol, polydispersity=1.86. DSC (10° C. min⁻¹, N₂): −69° C. (T_{g}). Refractive index=1.480.

### EXAMPLE 5

### Synthesis of HBP 5

One drop of PtCat was added to a solution of trifluoropropyltris (dimethylsiloxy) silane (2.55 grams, 7.28 mmol, 2.1 fold excess of SiH group) and 1,5-hexadiene (0.43 grams, 5.19 mmol) in toluene (10 mL). The reaction mixture was stirred at 50° C. for 5 days, and toluene was removed in vacuo. The crude product was washed with acetonitrile (3×10 mL) and dried in vacuo to give a pale yellow oil. ¹H NMR (CDCl₃) 1.99 mmol/g SiH. GPC (toluene/ELSD): Mₙ=3800 g/mol, M_{w}=9400 g/mol, polydispersity=2.46.

One drop of PtCat was then added to a solution of the pale yellow oil above (i.e., SiH-terminated polymer, 1.71 grams, 3.40 mmol SiH) and allyl methacrylate (0.43 grams, 3.40 mmol) in toluene (10 mL). The reaction mixture was stirred at room temperature for 2 days, and toluene was removed in vacuo to give the product as an oil. ¹H NMR (CDCl₃) 1.24 mmol/g methacrylate. GPC (toluene/ELSD): Mₙ=2600 g/mol, M_{w}=7100 g/mol, polydispersity=2.78. DSC (10° C. min⁻¹, N₂): −89° C. (T_{g}). Refractive index=1.424.

### EXAMPLE 6

### Synthesis of HBP 6

One drop of PtCat was added to a solution of bis[(p-dimethylsilyl)phenyl]ether (10.0 grams, 0.0349 mol, 3.1 fold excess of SiH group) and tetravinylsilane (0.79 grams, 5.82 mmol) in toluene (20 mL). The reaction mixture was stirred at 70° C. for 5 days, and toluene was removed in vacuo. The crude product was washed with acetonitrile (3×10 mL) and dried in vacuo to give a soft waxy solid. ¹H NMR (CDCl₃) 1.76 mmol/g SiH. GPC (toluene/ELSD): Mₙ=3400 g/mol, M_{w}=14000 g/mol, polydispersity=4.17.

One drop of PtCat was then added to a solution of the SiH-terminated polymer above (8.35 grams, 0.015 mol SiH) and allyl methacrylate (1.85 grams, 0.015mol) in toluene (20 mL). The reaction mixture was stirred at room temperature for 2 days, and toluene was removed in vacuo to give the product as a soft waxy solid. ¹H NMR (CDCl₃) 1.34 mmol/g methacrylate. GPC (toluene/ELSD): Mₙ=2500 g/mol, M_{w}=28000 g/mol, polydispersity=11. DSC (10° C. min⁻¹, N₂): −21° C. (T_{g}). Refractive index=1.549.

### EXAMPLE 7

### Synthesis of HBP 7

One drop of PtCat was added to a solution of 4,4′-bis (dimethylsilyl) biphenyl (1.96 grams, 7.23 mmol, 3.1 fold excess of SiH group) and tetravinylsilane (0.16 grams, 1.17 mmol) in toluene (10 mL). The reaction mixture was stirred at 70° C. for 3 days, and toluene was removed in vacuo. The crude product was washed with acetonitrile (3×10 mL) and dried in vacuo to give a soft waxy solid. ¹H NMR (CDCl₃) 2.47 mmol/g SiH. GPC (toluene/ELSD): Mₙ=2600 g/mol, M_{w}=8000 g/mol, polydispersity=3.07.

One drop of PtCat was then added to a solution of the SiH-terminated polymer above (1.54 grams, 3.80 mmol SiH) and allyl methacrylate (0.48 grams, 3.80 mmol) in toluene (10 mL). The reaction mixture was stirred at 60° C. for 2 days, and toluene was removed in vacuo to give the product as a soft waxy solid. ¹H NMR (CDCl₃) 1.38 mmol/g methacrylate. GPC (toluene/ELSD): Mₙ=2700 g/mol, M_{w}=14,000 g/mol, polydispersity=5.03. DSC (10° C. min⁻¹, N₂): −8° C. (T_{g}). Refractive index=1.567.

### ¹ H NMR Spectroscopy

¹H NMR samples were analyzed as solutions in deuterated chloroform. ¹H NMR spectroscopy was conducted using a Bruker AVANCE III 500 MHz NMR spectrometer equipped with a CPBBO gradient cryoprobe, a Bruker B-ACS 60 autosampler, and Bruker Topspin 3.04 software. Spectra were analyzed using Advanced Chemistry Development software (Toronto, Canada). Analysis of the chemical shifts and integrals in the proton spectra confirmed the formation of the target structures. End group content in mmol/g was calculated by comparing the integrals associated with end-groups with integrals associated with internal polymer repeat units.

### Gel Permeation Chromatography (GPC)

Solutions of approximate concentration 1.5 mg/mL were prepared in toluene. The samples were swirled on an orbital shaker for 12 hrs. The sample solutions were filtered through 0.45-micron PTFE syringe filters and then analyzed by GPC. An Agilent (Santa Clara, California) 1260 LC instrument was used with an Agilent “PLgel MIXED B+C” column at 40° C., toluene eluent at 1.0 mL/min, a NIST polystyrene standard (SRM 705a), and an Agilent 1260 Evaporative Light Scattering Detector.

### Differential Scanning Calorimetry (DSC)

DSC samples were prepared for thermal analysis by weighing and loading the material into TA Instruments (New Castle, Delaware) aluminum DSC sample pans. The specimens were analyzed using the TA Instruments Discovery Differential Scanning calorimeter (DSC-SN DSC1-0091) utilizing a heat-cool-heat method in standard mode (−155° C. to about 50° C. at 10° C./minute.). After data collection, the thermal transitions were analyzed using the TA Universal Analysis program. The glass transition temperatures were evaluated using the step change in the standard heat flow (HF) curves. The midpoint (half height) temperature of the second heat transition is reported.

### Measurement of Refractive Index

Refractive index was measured on a Milton Roy Company refractometer (model number: 334610). The liquid sample was sealed between two prisms and the refractive index was measured at 20° C. at the 589 nm line of a sodium lamp.

### EXAMPLES 7-16 and COMPARATIVE EXAMPLES A and B

### Curable Compositions

Omnirad TPO (1 phr) was added to the formulations in Table 2, and they were sonicated until a homogenous solution was formed. After purging in a chamber filled with a nitrogen atmosphere for 90 seconds, the coatings were cured using a UV-LED light with 395 nm wavelength (FJ801, Phoseon Technologies (Hillsboro, Oregon), 30 seconds per side, for a total radiation dose of ˜14 J/cm²). Table 2, below, reports various curable ink formulations.

TABLE 2

| EXAM- | PARTS BY WEIGHT | | | | | | | | | | | | | |
|---|---|---|---|---|---|---|---|---|---|---|---|---|---|---|
| PLE | CN309 | HPNDA | DDA | ISTA | IBOA | TAc | M360 | HBP 1 | HBP 2 | HBP 3 | HBP 4 | HBP 5 | HBP 6 | HBP 7 |
| COMPAR- | 20 | 40 | 40 | 0 | 0 | 0 | 0 | 0 | 0 | 0 | 0 | 0 | 0 | 0 |
| ATIVE | | | | | | | | | | | | | | |
| A | | | | | | | | | | | | | | |
| COMPAR- | 0 | 0 | 0 | 40 | 40 | 15 | 5 | 0 | 0 | 0 | 0 | 0 | 0 | 0 |
| ATIVE | | | | | | | | | | | | | | |
| B | | | | | | | | | | | | | | |
| 7 | 0 | 40 | 40 | 0 | 0 | 0 | 0 | 20 | 0 | 0 | 0 | 0 | 0 | 0 |
| 8 | 0 | 0 | 0 | 0 | 0 | 0 | 0 | 100 | 0 | 0 | 0 | 0 | 0 | 0 |
| 9 | 0 | 0 | 0 | 0 | 0 | 0 | 0 | 0 | 100 | 0 | 0 | 0 | 0 | 0 |
| 10 | 0 | 0 | 0 | 0 | 0 | 0 | 0 | 0 | 0 | 100 | 0 | 0 | 0 | 0 |
| 11 | 0 | 40 | 40 | 0 | 0 | 0 | 0 | 0 | 0 | 20 | 0 | 0 | 0 | 0 |
| 12 | 0 | 0 | 0 | 0 | 0 | 0 | 0 | 0 | 0 | 0 | 100 | 0 | 0 | 0 |
| 13 | 0 | 40 | 40 | 0 | 0 | 0 | 0 | 0 | 0 | 0 | 20 | 0 | 0 | 0 |
| 14 | 0 | 0 | 0 | 0 | 0 | 0 | 0 | 0 | 0 | 0 | 0 | 100 | 0 | 0 |
| 15 | 0 | 0 | 0 | 0 | 0 | 0 | 0 | 0 | 0 | 0 | 0 | 0 | 100 | 0 |
| 16 | 0 | 0 | 0 | 0 | 0 | 0 | 0 | 0 | 0 | 0 | 0 | 0 | 0 | 100 |

The refractive indexes of curable formulations are described in Table 3, below.

TABLE 3

| | REFRACTIVE INDEX |
|---|---|
| EXAMPLE | PRE-CURE |
| COMPARATIVE A | 1.457 |
| COMPARATIVE B | 1.465 |
| 8 | 1.476 |
| 9 | 1.473 |
| 10 | 1.483 |
| 11 | 1.459 |
| 12 | 1.480 |
| 13 | 1.461 |
| 14 | 1.424 |
| 15 | 1.549 |
| 16 | 1.567 |

Refractive indexes of corresponding cured formulations are described in Table 4. In Table 4, the percent curable methacrylate end group content is defined as the number of methacrylate end groups in the hyperbranched polymer/the total number of end groups in the hyperbranched polymer.

TABLE 4

| | % CURABLE | |
|---|---|---|
| | METHACRYLATE END | APPEARANCE |
| EXAMPLE | GROUP CONTENT | POST-CURE |
| COMPARATIVE A | not applicable | Transparent hardcoat |
| COMPARATIVE B | not applicable | Transparent hardcoat |
| 8 | 100 | Transparent hardcoat |
| 9 | 50 | Transparent soft tacky |
| | | solid |
| 10 | 100 | Transparent hardcoat |
| 12 | 75 | Transparent soft solid |

### Measurement of Glass Transition Temperature

Formulations were cured in a mold measuring approximately 1 mm thick, 5 mm wide and 10-12 mm long. A Dynamic Mechanical Analyzer (DMA) (Q800, TA Instruments, New Castle, Delaware) was used in “Multi-Frequency-Strain” mode. The sample was run at 1 KHz frequency under a temperature sweep from ambient to 160.00° C. at 3.00° C./min. The glass transition temperature (T_{g}) was captured as the peak of the tan delta curve. Results are reported in Table 5, below.

TABLE 5

| | T_{g} |
|---|---|
| EXAMPLE | POST-CURE |
| COMPARATIVE A | 108° C. |
| COMPARATIVE B | 76° C. |
| 7 | 140° C. |
| 11 | 132° C. |
| 13 | 109° C. |

### Measurement of Viscosity

Seventeen milliliters of material was loaded into a 25 mm diameter double gap coaxial concentric cylinder apparatus (DIN 53019) on a viscometer (BOHLIN VISCO 88, Malvern Instruments Ltd, Malvern, United Kingdom). A thermal jacket equipped to the double gap cell allowed for the flow of recirculating water heated to 25° C. and 50° C., respectively, and the system was allowed to equilibrate for 1 hour at each temperature prior to taking each measurement. Dynamic viscosity measurements in centipoise (cps) were taken at 25° C. and 50° C. at a shear rate of 1 s⁻¹. Results are reported in Table 6, below.

TABLE 6

| | VISCOSITY (cps) | VISCOSITY (cps) |
|---|---|---|
| EXAMPLE | 25° C. | 50° C. |
| COMPARATIVE A | <20 | <20 |
| COMPARATIVE B | <20 | <20 |
| 11 | <20 | <20 |
| 13 | <20 | <20 |

### Measurement of Dielectric Constant

Thick films of formulations were prepared for the dielectric spectroscopy measurement. The films were made by first taping easy and premium release liners to 5 in×5 in (12.7 cm×12.7 cm) borosilicate glass plates. L1 was used as an easy release liner, and L2 was used as a premium release liner. A 400 micron thick Teflon sheet with a 3 in (7.6 cm) diameter circle punched out of the center, along with a side injection port was clamped in between the two release liners. Three milliliters of each formulation was injected with a pipette into the construction via the injection port. The construction was clamped with binder clips and cured with a UV-LED light with 395 nm wavelength (FJ801, Phoseon Technologies (Hillsboro, Oregon) 30 seconds per side, for a total radiation dose of ˜14 J/cm². The samples were carefully removed from the cell and peeled from the liners.

The dielectric properties and electrical conductivity measurements were performed with an Alpha-A High Temperature Broadband Dielectric Spectrometer modular measurement system from Novocontrol Technologies Gmbh (Montabaur, Germany). All testing was performed in accordance with the ASTM D150 test standard. The films were painted with copper paint. The Novocontrol ZGS Alpha Active Sample Cell was implemented once each sample was placed between two optically polished brass disks (diameter 40.0 mm and thickness 2.00 mm).

Results are reported in Table 7, below.

TABLE 7

| | DIELECTRIC CONSTANT at 1 MHz |
|---|---|
| EXAMPLE | (Post cure) |
| COMPARATIVE B | 2.6 |
| 8 | 3.0 |

### Plasma Etch Testing

A silicon wafer (4-inch (10-cm) diameter, University Wafer, Boston, Massachusetts) was cleaned with acetone and isopropanol. The silicon wafer was placed on a hot plate at 250° C. for 10 min to dehydrate, then ozone treated for 5 minutes (Novascan PSD Pro series Digital UV ozone System). Example Formulations, as described by Table 2, were coated onto the wafers using a film applicator bar (BYK Additives and Instruments, Wesel Germany, Model 46245) and cured under a 395 nm UV-LED light (Phoseon Technologies FJ801 Controller) after a 90 second N2 purge. The samples were partially covered with tape (3M Polyester Green Tape, product number 8403, 25 3M Company) and treated with oxygen plasma for five minutes (Yield Engineering System G1000, Gas=−12-100 % O₂, Flow=60 sccm, RF Power=300W, Time=300 seconds). The tape was removed, and the sample was analyzed with white light interferometry (Contour GTX-8, Bruker Inc., Billerica, Massachusetts) at the interface of the film area that was partially covered with tape. Vision 64 software and its “modal tilt only” function were used to level the data in order to calculate the step edge (Bruker Inc., Billerica, Massachusetts) and determine the step height. The Comparative Example B showed significant etching as a result of exposure to plasma relative to the side of the sample that was covered with tape (“unetched”) during the exposure to plasma. An ink formulation with the etch-resistant additive, Example (ink) 7 showed no significant etching as a result of exposure to plasma when comparing the etched to the unetched side of the film. Table 8, below, reports etch depth after five minutes exposure to oxygen plasma and calculated etch rate.

TABLE 8

| | STEP HEIGHT, | ETCH RATE. |
|---|---|---|
| EXAMPLE | microns | nm/min |
| COMPARATIVE B | 0.2211 | 44.2 |
| 7 | 0.0049 | 0.98 |

All cited references, patents, and patent applications in this application are incorporated in a consistent manner. In the event of inconsistencies or contradictions between portions of the incorporated references and this application, the information in this application shall control.

The preceding description, given in order to enable one of ordinary skill in the art to practice the claimed disclosure, is not to be construed as limiting the scope of the disclosure, which is defined by the claims and all equivalents thereto.

1. A (meth)acrylated hyperbranched polymer consisting of C, H, Si, optionally O, and optionally F atoms, wherein the (meth)acrylated hyperbranched polymer comprises end groups, and wherein at least some of the end groups comprise (meth)acryloyloxy groups.

2. The (meth)acrylated hyperbranched polymer of claim 1, wherein the (meth)acrylated hyperbranched polymer comprises a first reaction product of first components comprising:
i) a primary alkenyl (meth)acrylate;
ii) a hyperbranched polymer comprising a second reaction product of second components comprising:
a) at least one first monomer component independently having p Si—H groups and consisting of C, H, Si, optionally O, and optionally F atoms, wherein each p is independently an integer greater than or equal to 2;
b) at least one second monomer component independently having q vinyl groups and consisting of C, H, optionally Si, optionally F, and optionally O atoms, wherein each q is independently an integer greater than or equal to 2, wherein p/q is at least 2.1; and
c) at least one hydrosilylation reaction catalyst.

3. The (meth)acrylated hyperbranched polymer of claim 2, wherein p/q is at least 3.1.

4. The (meth)acrylated hyperbranched polymer of claim 2, wherein the first components further comprise iii) a primary monoalkene.

5. The (meth)acrylated hyperbranched polymer of claim 2, wherein the at least one second monomer component comprises at least one compound represented by the formula
Si(SiR²₂CH═CH₂)_{b}(R₂CH═CH₂)_{c}(R³)_{d}
wherein each R² is independently a direct bond or a hydrocarbylene group having 1 to 12 carbon atoms, each R³ is independently a hydrocarbyl group having from 1 to 12 carbon atoms, b is an integer from 0 to 4, c is an integer from 0 to 4, and d is an integer from 0 to 2, with the proviso that b+c≥2 and b+c+d=4.

6. The (meth)acrylated hyperbranched polymer of claim 5, wherein the at least one second monomer component is selected from the group consisting of tetravinylsilane, and tetraallylsilane.

7. The (meth)acrylated hyperbranched polymer of claim 2, wherein the at least one first monomer component is independently represented by the formula
Z(SiR¹₂H)ₐ
wherein Z is an a-hydrosilyl radical composed of Si and O or Z is an a-hydrosilyl radical composed of C, H, optionally O, and optionally F wherein Z has from 1 to 12 carbon atoms, each R¹ is independently a hydrocarbyl group having from 1 to 12 carbon atoms, and a is an integer from 2 to 8.

8. The (meth)acrylated hyperbranched polymer of claim 7, wherein the at least one first monomer component comprises H(CH₃)₂SiCH₂CH₂Si(CH₃)₂H, H(CH₃)₂Si—C₆H₄—O—C₆H₄—Si(CH₃)₂H, H(CH₃)₂Si—C₆H₄—C₆H₄—Si(CH₃)₂H, CF₃(CH₂)₂Si(OSi(CH₃)₂H)₃ or a combination thereof.

9. A method of making a hyperbranched polymer, the method comprising:
i) forming a hyperbranched polymer by combining first components comprising:
a) at least one first monomer component independently having p Si—H groups and consisting of C, H, Si, optionally O, and optionally F atoms, wherein each p is independently an integer greater than or equal to 2;
b) at least one second monomer component independently having q vinyl groups and consisting of C, H, optionally Si, optionally O atoms, and optionally F atoms, wherein each q is independently an integer greater than or equal to 2, wherein p/q is at least 2.1 to form a hyperbranched polymer;
c) at least one hydrosilylation reaction catalyst; and
ii) endcapping the hyperbranched polymer with at least one primary alkenyl (meth)acrylate.

10. The method of claim 9, wherein p/q is at least 3.1.

11. The method of making a hyperbranched polymer of claim 9, wherein the at least one second component further comprises a primary monoalkene.

12. A curable composition comprising:
the (meth)acrylated hyperbranched polymer of claim 1;
at least one free-radically polymerizable monomer having at least one (meth)acryloyloxy groups; and
an effective amount of a free-radical initiator for curing the curable composition, wherein at least one component in the curable composition carries at least two (meth)acryloyloxy groups.

13. The curable composition of claim 12, wherein the free-radical initiator comprises free-radical photoinitiator.

14. The curable composition of claim 12, wherein the curable composition has a refractive index of from 1.40 to 1.60.

15. An at least partially cured curable composition according to claim 12.

16. The at least partially cured curable composition of claim 15, wherein the at least partially cured curable composition has a dielectric constant of less than or equal to 3.0 at a measurement frequency of 1 megahertz.

17. The at least partially cured curable composition of claim 15, wherein the at least partially cured curable composition has a glass transition temperature of at least 100 degrees Celsius.

18. An electronic device comprising the at least partially cured curable composition of claim 15 disposed on an optical electronic component.

19. The electronic device of claim 18, wherein the optical electronic component comprises at least one of an organic light emitting diode, a quantum dot light emitting diode, a micro light emitting diode, or a quantum nanorod electronic device.

20. The electronic device of claim 19, wherein the optical electronic component comprises an organic light emitting diode.
